(19) United States
(12) Patent Application Publication
(10) Pub. No.: US 2026/0128114 A1
(43) Pub. Date: May 7, 2026

(54) MEMORY DEVICE WITH BUILT-IN SELF-TEST

(71) Applicant: PUFsecurity CORPORATION, ZHUBEI CITY (TW)

(72) Inventors: CHI-YI SHAO, HSINCHU COUNTY (TW); CHIA-CHO WU, HSINCHU COUNTY (TW)

(21) Appl. No.: 19/378,048

(22) Filed: Nov. 3, 2025

Related U.S. Application Data
(60) Provisional application No. 63/715,647, filed on Nov. 4, 2024.

(51) Int. Cl. G11C 29/44; G06F 21/75

(52) U.S. Cl. CPC G11C 29/44; G06F 21/75

(57) ABSTRACT

The present application discloses a memory device. The memory device includes a one-time programmable (OTP) cell array, a physical unclonable function (PUF) cell array, and a controller. The OTP cell array includes a plurality of OTP cells. The PUF cell array includes a plurality of PUF cells. The controller performs a first read operation upon the PUF cell array to read a plurality of first bit values, performs a second read operation upon the PUF cell array to read a plurality of second bit values after the first read operation, performs a comparison operation upon the first bit values and the second bit values, and determines whether to allow an OTP load operation for reading the OTP cell array according to a result of the comparison operation.

### CROSS REFERENCE

This application claims the benefit of prior-filed U.S. provisional application No. 63/715,647, filed on November 4, 2024, which is incorporated by reference in its entirety.

### TECHNICAL FIELD

The present disclosure relates to a memory device, and more particularly, to a memory device with a built-in self-test (BIST) function.

### DISCUSSION OF THE BACKGROUND

Generally, when a system on chip (SoC) powers up, it follows a predefined boot sequence. For example, upon powering on, the SoC first performs basic hardware initialization. It then reads configuration data, such as security keys, boot configuration, and hardware settings, from the one-time programmable (OTP) memory for system setting and verification. Afterwards, the SoC may further proceed with CPU initialization, execute the bootloader from the read-only memory (ROM), and finally start the operating system (OS).

However, during the initial stages of the SoC's boot process, the system voltages may not yet be stable. Such instability can lead to errors when reading data from the OTP memory. Since the data stored in the OTP memory may include critical content, such as system security keys and configuration data, the authentication and the boot process of the SoC may fail if the data are not correctly read from the OTP memory. Therefore, how to ensure the stability of OTP memory before reading data from it has become an issue to be solved.

### SUMMARY

One aspect of the present disclosure provides a memory device. The memory device includes a one-time programmable (OTP) cell array, a physical unclonalbe function (PUF) cell array, and a controller. The OTP cell array includes a plurality of OTP cells. The PUF cell array includes a plurality of PUF cells. The controller performs a first read operation upon the PUF cell array to read a plurality of first bit values, performs a second read operation upon the PUF cell array to read a plurality of second bit values after the first read operation, performs a comparison operation upon the plurality of first bit values and the plurality of second bit values, and determines whether to allow an OTP load operation for reading the OTP cell array at least according to a result of the comparison operation.

Another aspect of the present disclosure provides a method for confirming stability of a memory device. The memory device includes an OTP cell array, a PUF cell array, and a controller. The OTP cell array includes a plurality of OTP cells, and the PUF cell array includes a plurality of PUF cells. The method includes performing a first read operation upon the PUF cell array to read a plurality of first bit values, performing a second read operation upon the PUF cell array to read a plurality of second bit values after the first read operation, performing a comparison operation upon the plurality of first bit values and the plurality of second bit values, and determining whether to allow an OTP load operation for reading the OTP cell array at least according to a result of the comparison operation.

### BRIEF DESCRIPTION OF THE PLOTTINGS

A more complete understanding of the present disclosure may be derived by referring to the detailed description and claims when considered in connection with the Figures, where like reference numbers refer to similar elements throughout the Figures.

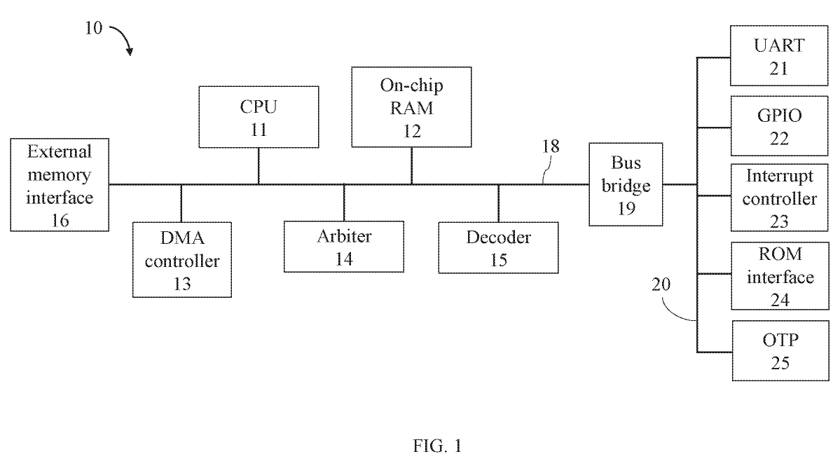

FIG. 1 shows a system on chip (SoC) according to one embodiment of the present disclosure.

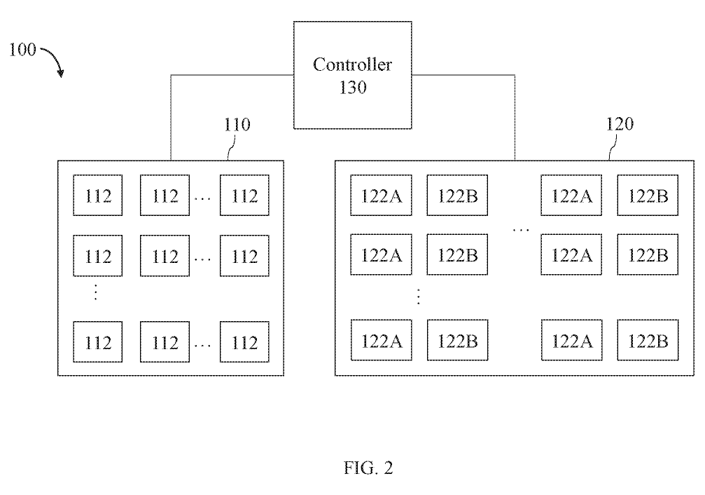

FIG. 2 shows a memory device according to one embodiment of the present disclosure.

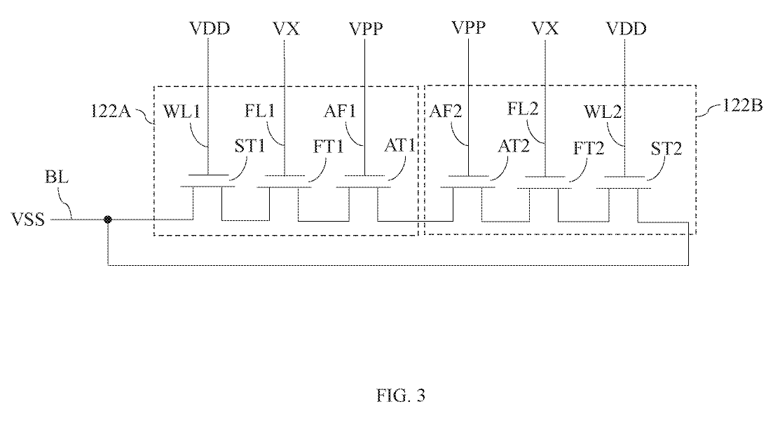

FIG. 3 shows the paired PUF cells according to one embodiment of the present disclosure.

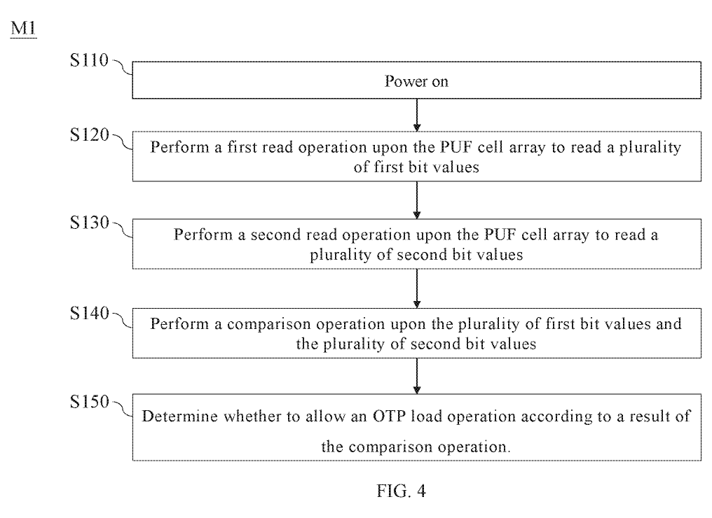

FIG. 4 shows a flow chart of a method for confirming the stability of the memory device according to one embodiment of the present disclosure.

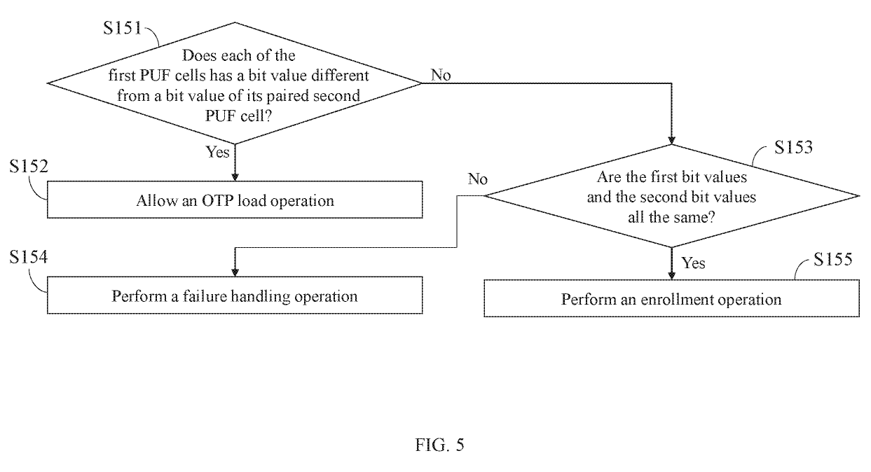

FIG. 5 shows a flow chart for performing a step for determining whether to allow an OTP load operation according to one embodiment of the present disclosure.

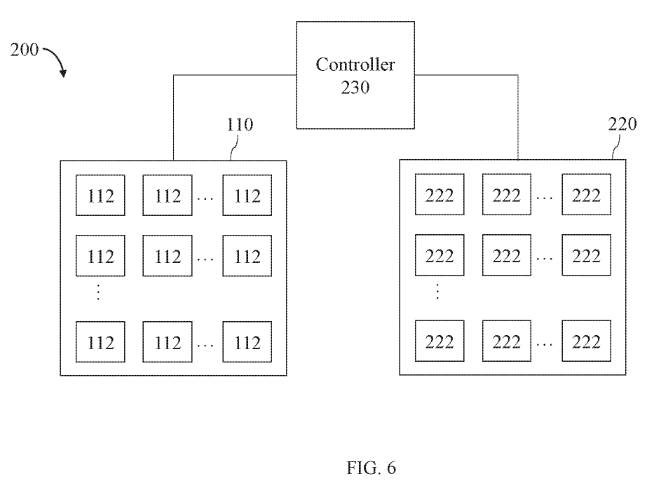

FIG. 6 shows a memory device according to another embodiment of the present disclosure.

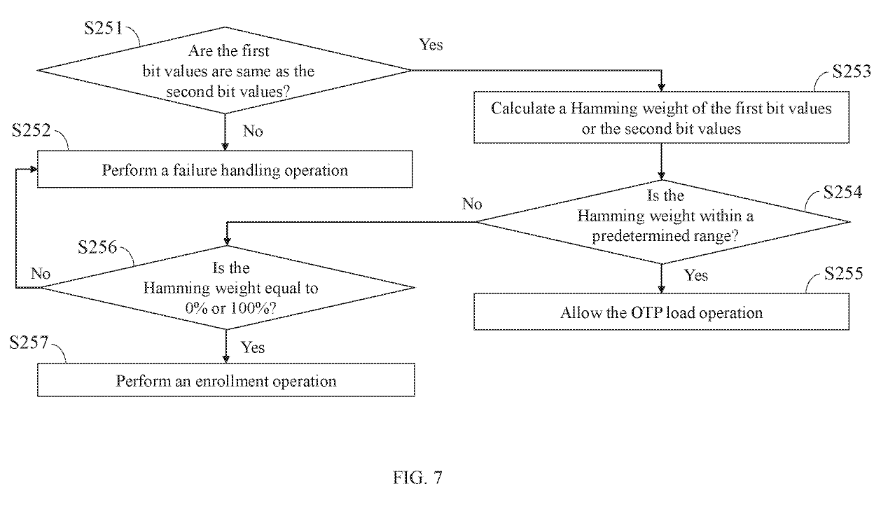

FIG. 7 shows a flow chart for performing a step for determining whether to allow an OTP load operation according to another embodiment of the present disclosure.

### DETAILED DESCRIPTION

FIG. 1 shows a system on chip (SoC) 10 according to one embodiment of the present disclosure. The SoC 10 is an integrated circuit that integrate various components of a computer or other electronic systems onto a single chip. For example, the SoC 10 may include a central process unit (CPU) 11, an On-chip random access memory (RAM) 12, a direct memory access (DMA) controller 13, an arbiter 14, and a decoder 15.

The CPU 11 is the main processing unit of the SoC 10 that executes instructions and performs calculations. The on-chop RAM 12 is a memory integrated into the SoC 10, used for temporary data storage and quick access by the CPU 11. The DMA controller 13 manages the direct transfer of data between memory and peripherals without involving the CPU 11 so as to increase the data transfer efficiency and reduce the burden of the CPU. In the present embodiment, the CPU 11 may further be coupled to an external memory through the external memory interface 16, and in some embodiments, the DMA controller 13 may also be adopted to access the external memory through the external memory interface 16.

As shown in FIG. 1, the CPU can be coupled to the On-chip RAM 12, the DMA controller 13, and the external memory interface 16 through an advance high-performance bus (AHB) 18, and the arbiter 14 and the decoder 15 can be adopted to manage the access of the AHB 18. In addition, the CPU 11 may further be coupled to other peripheral circuits. For example, the peripheral circuits may include a universal asynchronous receiver/transmitter (UART) 21, general purpose input/outputs (GPIO) 22, an interrupt controller 23, a ROM interface 24, and a one-time programmable (OTP) memory 25, and the peripheral circuits may be coupled to an advanced peripheral bus (APB) 20. In such case, the CPU 11 may access the peripheral circuits through a bus bridge 19 that interfacing between the AHB 18 and the APB 20.

When the SoC 10 powers up, it may follow a predefined boot sequence. For example, upon powering on, the SoC 10 may first perform a basic hardware initialization, and then, it may read configuration data from the OTP memory 25 for system setting and verification. Afterwards, the SoC 10 may further initialize the CPU 11, execute the bootloader from the ROM, and finally start the OS. In the aforementioned boot sequence, the OTP memory 25 is accessed in an early stage in which the voltages required by the read operation of the OTP memory 25 may still be instable. As a result, the data read from the OTP memory 25 may be incorrect, which may lead to the verification failures and, consequently, system failures.

To avoid the failure caused by the instability, the present disclosure proposes a memory device supporting a built-in self-test (BIST) that can confirm the stability of the OTP memory before performing read operations upon the OTP memory with the aid of physical unclonable function (PUF) cells.

FIG. 2 shows a memory device 100 according to one embodiment of the present disclosure. The memory device 100 includes an OTP cell array 110, a PUF cell array 120, and a controller 130. The OTP cell array 110 includes a plurality of OTP cells 112. In some embodiments, the memory device 100 may be adopted to replace the OTP memory 25 in the SoC 10. In such case, the OTP cell array 110 may store system configuration data of a processor (e.g., the CPU 11) that is coupled to the memory device 100. However, the present disclosure is not limited thereto. In some embodiments, the memory device 100 can be incorporated in other applications or systems.

In the present embodiment, the OTP cell array 110 and the PUF cell array 120 may have similar structures and may require same voltages for operations. For example, but not limited to, both of them can be anti-fuse based memory. In such case, before performing an OTP load operation (e.g., an auto load OTP operation performed in the boot sequence of the SoC 10) to read the configuration data to the CPU 11, the controller 130 may perform read operations upon the PUF cell array 120 and check the correctness of the read operations for the PUF cell array 120 so as to confirm the stability of the OTP cell array 110. In some embodiments, the memory device 100 may further include other peripheral circuits, such as address decoders, drivers, and/or bias circuits, that can be used for performing the read/write operation upon the OTP cell array 110 and the PUF cell array 120 by the control of the controller 130. However, those peripheral circuits are not shown in the figures of the present disclosure for brevity.

In the present embodiment, the PUF cell array 120 includes a plurality of PUF cells 122A and 122B, and each two of the PUF cells are paired. Specifically, each pair of PUF cells may include one PUF cell 122A and one PUF cell 122B, and the paired PUF cells 122A and 122B can be enrolled simultaneously to have complementary bit values according to their physical characteristics after enrollment.

FIG. 3 shows the paired PUF cells 122A and 122B according to one embodiment of the present disclosure. In the present embodiment, the PUF cells 122A and 122B are anti-fuse based PUF cells. The PUF cell 122A includes an antifuse transistor AT1, a following gate transistor FT1, and a selection transistor ST1. The PUF cell 122B includes an antifuse transistor AT2, a following gate transistor FT2, and a selection transistor ST2.

The selection transistor ST1 has a first terminal coupled to a bit line BL, a second terminal, and a control terminal coupled to a word line WL1. The following gate transistor FT1 has a first terminal coupled to the second terminal of the selection transistor ST1, a second terminal, and a control terminal coupled to a following gate control line FL1. The antifuse transistor AT1 has a first terminal coupled to the second terminal of the following gate transistor FT1, a second terminal, and a gate terminal coupled to an operation control line AF1.

Also, the selection transistor ST2 has a first terminal coupled to the bit line BL, a second terminal, and a control terminal coupled to a word line WL2. The following gate transistor FT2 has a first terminal coupled to the second terminal of the selection transistor ST2, a second terminal, and a control terminal coupled to a following gate control line FL2. The antifuse transistor AT2 has a first terminal coupled to the second terminal of the following gate transistor FT2, a second terminal coupled to the second terminal of the antifuse transistor AT1, and a gate terminal coupled to an operation control line AF2.

When the PUF cells 122A and 122B are in an initial state before enrollment, the gate structures of the antifuse transistors AT1 and AT2 are in a high-resistance state. In such case, when performing a read operation upon the PUF cell 122A or 122B by applying a high voltage to the word lines WL1, WL2 and the following gate control lines FL1, FL2 and applying a sense voltage to the operation control line AF1 or AF2, only an insignificant current or zero current will be sensed on the bit line BL since the gate structures of the antifuse transistors AT1 and AT2 are in the high-resistance state. That is, in the initial state, the PUF cells 122A and 122B may have the same bit value, for example but not limited to, the bit value "0".

However, if the gate structure of the antifuse transistor AT1 or AT2 is ruptured, then the gate structure of the antifuse transistor AT1 or AT2 would be in a low-resistance state, and the bit value would be changed accordingly. For example, if the gate structure of the antifuse transistor AT1 has been ruptured, then during the read operation of the PUF cell 122A, the antifuse transistor AT1 would conduct a significant current on the bit line BL, which may indicate that the PUF cell 122A, for example but not limited to, a bit value "1".

In the present embodiment, the PUF cells 122A and 122B needs to be enrolled so as to acquire their unpredictable bit values according to their physical characteristics. Furthermore, in the present embodiment, after enrollment, the PUF cells 122A and 122B will have complementary bit values. That is, one of the PUF cells 122A and 122B will have a bit value "0" and the other one of the PUF cells 122A and 122B will have a bit value "1". Specifically, FIG. 3 also shows the voltages received by the PUF cells 122A and 122B during an enrollment operation.

As shown in FIG. 3, when performing the enrollment operation upon the PUF cells 122A and 122B, the bit line BL can receive a low voltage, such as a ground voltage or a system reference voltage VSS, and the word lines WL1 and WL2 can receive a high voltage, such as a power voltage VDD of the memory device 100. Also, the operation control lines AF1 and AF2 can receive a program voltage VPP higher than the power voltage VDD, and the following gate control lines FL1 and FL2 can receive a following gate high voltage VX that is between the program voltage VPP and the power voltage VDD. In such case, the selection transistors S1, S2 and the following gate transistors W1 and W2 are turned on. Therefore, the antifuse transistors AT1 and AT2 would receive high voltage stress between their source/drain terminals and their gate terminals, making their gate structures prone to be ruptured. However, due to the different intrinsic characteristics caused by manufacturing variations of the PUF cells 122A and 122B, such as gate oxide quality, local defects, gate oxide thinning, etc., one of the antifuse transistors AT1 and AT2 of the PUF cells 122A and 122B will be ruptured first. Furthermore, the antifuse transistor being ruptured first will have its gate structure in a low-resistance state, thereby coupling the source/drain terminals of the other antifuse transistor to an intermediate voltage to reduce the stress applied to the other antifuse transistor and to prevent the other antifuse transistor from being ruptured. Therefore, after enrollment, the PUF cells 122A and 122B will have different bit values.

FIG. 4 shows a flow chart of a method M1 for confirming the stability of the memory device 100 according to one embodiment of the present disclosure.

In step S110, the memory device 100 is powered on. In step S120, the controller 130 may perform a first read operation upon the PUF cell array 120 to read a plurality of first bit values, and in step S130, the controller 130 may further perform a second read operation upon the PUF cell array 120 to read a plurality of second bit values after the first read operation. In the present embodiment, the first read operation is performed to read at least a part of the PUF cells 122A in the PUF cell array 120 while the second read operation is performed to read at least a part of the PUF cells 122B in the PUF cell array 120 that are paired with the PUF cells 122A read in the first read operation. That is, the first bit values read in the first read operation include bit values of some of the PUF cells 122A, and the second bit values read in the second read operation include bit values of the PUF cells 122B that are paired with the PUF cells 122A read in the first read operation.

In such case, the first bit values read by the first read operation in step S120 should be different from the second bit values read by the second read operation in step S130 if the paired PUF cells 122A and 122B have been enrolled to have complementary bit values as aforementioned. Therefore, in step S140, the controller 130 may perform a comparison operation upon the first bit values read by the first read operation in step S120 and the second bit values read by the second read operation in step S130, and in step S150, the controller 130 may determine whether to allow the OTP load operation according to the result of the comparison operation.

FIG. 5 shows a flow chart for performing the step S150 according to one embodiment of the present disclosure. In step S151, if each of the PUF cells 122A read in the first read operation has a bit value different from a bit value of its paired PUF cell 122B, then it may imply that the two read operations have been performed correctly, and the system voltages utilized for the two read operations have become stable. Therefore, the memory device 100 may have become stable and ready for the read operations. Therefore, as shown in FIG. 5, if each of the first bit values read in the first read operation is determined to be different from the corresponding second bit value read in the second read operation, it will proceed to step S152 and the OTP load operation can be performed upon the OTP cell array 110 accordingly.

However, if any of the first bit values read in the first read operation is same as the corresponding second bit value read in the second read operation (i.e., if any of the paired PUF cells 122A and 122B are read to have the same bit value), then it may imply that at least one of the two read operations has not been performed correctly, and the system voltages utilized for the two read operations may not yet become stable. Therefore, the memory device 100 may not yet become stable and is not ready for the read operations. In such case, the memory device 100 should not allow the OTP load operation, and the controller 130 may perform a failure handling operation accordingly in step S154. The failure handling operation may include at least one of sending an alarm (e.g., to notify the processor, such as the CPU 11) and forbidding the OTP load operation.

In addition, in some embodiments, if the comparison result indicates that the first bit values read by the first read operation and the second bit values read by the second read operation are all the same (e.g., the first bit values and the second bit values are all "0"), it may imply that the PUF cells in the PUF cell array 120 are still in the initial state and have not been enrolled yet. Therefore, as shown in FIG. 5, if the condition in step S151 is not satisfied (i.e., if any of the paired PUF cells 122A and 122B are read to have the same bit value), then it would further be determined, in step S153, if all the first bit values of the PUF cells 122A read in the first read operation and the second bit values of the PUF cells 122B read in the second read operation are all the same. If the first bit values and the second bit values are all the same, then step S155 would be performed so as to enroll the PUF cell array 120; otherwise, it may imply that the memory device 100 does not function normally, and step S154 can be performed to handle the failure.

It should be noted that, the present disclosure is not limited to the sequence of steps shown in FIG. 4. For example, in some embodiments, the controller 130 may perform the comparison every time when a PUF cell 122A is read in step S120 and a PUF cell 122B is read in step S130. In such case, steps S120, S130, and S140 may be performed repeatedly before the step S150 is performed.

In addition, the structure of PUF cells 122A and 122B shown in FIG. 3 are provided for illustrative purposes only and are not intended to be limiting. In some embodiments, other structures may be adopted to implement the PUF cells in the PUF cell array 120. In some embodiments, the PUF cells may have intrinsic bit values according to their unpredicted physical characteristics, and do not need the enrollment process. In such case, steps S153 and S155 may be omitted, and step S154 may be performed when the result of the comparison operation indicates that a first PUF cell 122A has a bit value same as a bit value of its paired second PUF cell 122B, that is, when the condition required by step S151 is not satisfied.

Furthermore, in some embodiments, unlike the paired PUF cells 122A and 122B having complementary bit values in the PUF cell array 120, the PUF cells may have their bit values independent of each other, such as the ring oscillator PUF cells. In other embodiments, the paired PUF cells may always have complementary bit values regardless of stability of the system voltages, such as the static random-access memory (SRAM) PUF cells. In those cases, the step S150 may be performed with a different flow.

FIG. 6 shows a memory device 200 according to another embodiment of the present disclosure. The memory device 200 is different from the memory device 100 at least in that the bit values of the PUF cells 222 in the PUF cell array 220 may be independent of each other. That is, the PUF cells 222 needs not to be paired as the PUF cells 122A and 122B in the PUF cell array 120.

In the present embodiment, the method M1 can also be applied to test the stability of the memory device 200 and determine whether to allow the OTP load operation.

Specifically, in step S120, the controller 230 may perform the first read operation to read a plurality of first bit values from at least part of the PUF cells 222 in the PUF cell array 220. Also, in step S130, the controller 230 may perform a second read operation to read a plurality of second bit values from the same part of the PUF cells 222 again. In step S140, the controller 230 may compare the first bit values read in step S120 and the second bit values read in step S130. In the present embodiment, since the first read operation in step S120 and the second read operation in step S130 are performed upon the same PUF cells 222, the comparison result should indicate that the first bit values are same as the second bit values if the memory device 200 is stable and the first read operation and the second read operation have been performed properly. Therefore, according to the comparison result, the controller 230 may determine whether to allow the OTP load operation in step S150.

FIG. 7 shows a flow chart for performing step S150 according to another embodiment of the present disclosure. In the present embodiment, step S150 may include steps S251 to S257.

In step S251, the controller 230 may check whether the first bit values are same as the second bit values. If the result of the comparison operation indicates that first bit values read by the first read operation are different from the second bit values read by the second read operation (i.e., the condition required by step S251 is not satisfied), then it may imply that at least one of the first read operation and the second read operation is not performed properly. In such case, it will proceed to step S252 to perform the failure handling operation accordingly. In some embodiments, the failure handling operation may include sending an alarm and/or forbidding the OTP load operation.

However, if the result of the comparison operation indicates that the first bit values read by the first read operation are same as the second bit values read by the second read operation (i.e., the two bit values of each PUF cell acquired in the two read operations are identical), then the controller 230 may proceed to perform step S253 to calculate a Hamming weight of the first bit values or the second bit values. The Hamming weight can indicate the percentage of the bit values "1" among all the bit values. For example, if the controller 230 reads one thousand bit values from one thousand PUF cells 222 in the PUF cell array 220, and there are four hundred and fifty PUF cells 222 having the bit value "1", then the Hamming weight would be 45%.

Generally, the Hamming weight of the first bit values (or the second bit values) may indicate if the bit values of the PUF cells 222 are significantly biased, and can thus be used to verify the functionality of the PUF cell array 220. In some embodiments, if the Hamming weight is within a predetermined range, for example, but not limited to, from 40% to 60%, then it may imply that the randomness of the PUF cell array 220 is acceptable since the bit values of the PUF cells 222 are not obviously biased. Good randomness may indicate that the system voltages for reading the PUF cell array 220 have been stable. In such case, the condition required by step S254 is satisfied, and step S255 can be performed to allow the OTP load operation.

Otherwise, if the condition required by step S254 is not satisfied (i.e., the Hamming weight is outside the predetermined range), then step S256 may be performed to check if the Hamming weight is 0% or 100%. If the Hamming weight is equal to 0% or 100%, it may imply that the PUF cell array 220 has not been enrolled, and thus, the controller 230 may proceed to step S257 to perform the enrollment operation upon the PUF cells 222 of the PUF cell array 220.

Otherwise, if the Hamming weight is not within the predetermined range, and is not equal to 0% or 100%, then it may imply that the PUF cell array 220 is not function normally, and the controller 230 may proceed to step S252 to perform the failure handling operation.

In some embodiments, the PUF cells 222 may have intrinsic bit values according to their unpredicted physical characteristics, and do not need to the enrollment process. In such case, steps S256 and S257 may be omitted, and step S252 may be performed if it is determined that the Hamming weight is not within the predetermined range in step S254.

In some embodiments, the flow chart shown in FIG. 7 for performing step S150 can also be applied to PUF cell arrays having PUF cells that are paired to have complementary bit values. That is, the flow chart shown in FIG. 7 can be applied to the PUF cell array 120 and the PUF cell array that uses SRAM to store the unpredicted bit values.

In some embodiments, when the flow chart in FIG. 7 is applied to the PUF cell array 120, the PUF cells 122A or the PUF cells 122B can be read twice so as to check if the memory device 100 is ready and stable according to the consistency of the results of the two read operations. For example, the first read operation in step S120 and the second read operation in step S130 can both be performed upon the same PUF cells, such as the PUF cells 122A. Therefore, if the memory device 100 is stable and ready, then the bit values obtained in the two read operations should be the same. Otherwise, if the bit values obtained in the two read operations are different, then it may imply that at least one of the two read operations has not been performed correctly and the memory device 100 may not be ready and stable. In such case, steps S251 to S257 can be performed to determine whether to allow the OTP load operation or not.

In summary, the memory devices and the methods for confirming stability of memory devices can perform read operations upon the PUF cell array so as to confirm the stability of the memory device before allowing the read operations to the OTP cell array. Therefore, the OTP load operation can be performed properly in a stable state, reducing the failure caused by voltage instability during an early stage of a system initialization process.

What is claimed is:

1. A memory device comprising:
a one-time programmable (OTP) cell array comprising a plurality of OTP cells;
a physical unclonable function (PUF) cell array comprising a plurality of PUF cells; and
a controller configured to perform a first read operation upon the PUF cell array to read a plurality of first bit values, perform a second read operation upon the PUF cell array to read a plurality of second bit values after the first read operation, perform a comparison operation upon the plurality of first bit values and the plurality of second bit values, and determine whether to allow an OTP load operation for reading the OTP cell array at least according to a result of the comparison operation.

2. The memory device of claim 1, wherein:
each two of the plurality of PUF cells are configured to be paired and have complementary bit values according to their physical characteristics; and
the plurality of first bit values comprise bit values of a plurality of first PUF cells of the plurality of PUF cells and the plurality of second bit values comprise bit values of a plurality of second PUF cells of the plurality of PUF cells that are paired with the plurality of first PUF cells.

3. The memory device of claim 2, wherein the controller determines to allow the OTP load operation when the result of the comparison operation indicates that each first PUF cell of the plurality of first PUF cells has a bit value different from a bit value of a second PUF cell of the plurality of second PUF cells paired with the first PUF cell.

4. The memory device of claim 2, wherein:
the controller determines to perform a failure handling operation when the result of the comparison operation indicates that a first PUF cell of the plurality of first PUF cells has a bit value same as a bit value of a second PUF cell of the plurality of second PUF cells paired with the first PUF cell,
wherein the failure handling operation comprises at least one of sending an alarm and forbidding the OTP load operation.

5. The memory device of claim 2, wherein the controller determines to perform an enrollment operation upon the plurality of PUF cells when the result of the comparison operation indicates that the plurality of first bit values and the plurality of second bit values are all the same.

6. The memory device of claim 1, wherein:
the first read operation is performed to read the plurality of first bit values from at least part of the plurality of PUF cells and the second read operation is performed to read the plurality of second bit values from the at least part of the plurality of PUF cells again.

7. The memory device of claim 6, wherein bit values of the plurality of PUF cells are independent of each other.

8. The memory device of claim 6, wherein:
the plurality of PUF cells comprise a plurality of first PUF cells and a plurality of second PUF cells, and each of the plurality of first PUF cells is paired with a second PUF cell of the plurality of second PUF cells to have complementary bit values; and
the first read operation and the second read operation are performed upon the plurality of first PUF cells.

9. The memory device of claim 6, wherein:
the controller determines to perform a failure handling operation when the result of the comparison operation indicates that the plurality of first bit values read by the first read operation are different from the plurality of second bit values read by the second read operation; and
the failure handling operation comprises at least one of sending an alarm and forbidding the OTP load operation.

10. The memory device of claim 6, wherein when the result of the comparison operation indicates that the plurality of first bit values read by the first read operation are same as the plurality of second bit values read by the second read operation, the controller is further configured to calculate a Hamming weight of the plurality of first bit values or the plurality of second bit values.

11. The memory device of claim 10, wherein the controller determines to allow the OTP load operation when the Hamming weight is within a predetermined range.

12. The memory device of claim 11, wherein the controller is further configured to perform an enrollment operation upon the plurality of PUF cells when the Hamming weight is 0% or 100%, and perform a failure handling operation when the Hamming weight is not 0%, 100% nor within the predetermined range, wherein the failure handling operation comprises at least one of sending an alarm and forbidding the OTP load operation.

13. A method for confirming stability of a memory device, wherein the memory device comprises an one-time programmable (OTP) cell array, and a physical unclonable function (PUF) cell array, the OTP cell array comprises a plurality of OTP cells, the PUF cell array comprises a plurality of PUF cells, and the method comprises:
performing a first read operation upon the PUF cell array to read a plurality of first bit values;
performing a second read operation upon the PUF cell array to read a plurality of second bit values after the first read operation;
performing a comparison operation upon the plurality of first bit values and the plurality of second bit values; and
determining whether to allow an OTP load operation for reading the OTP cell array at least according to a result of the comparison operation.

14. The method of claim 13, wherein:
each two of the plurality of PUF cells are configured to be paired and have complementary bit values according to their physical characteristics; and
the plurality of first bit values comprise bit values of a plurality of first PUF cells of the plurality of PUF cells and the plurality of second bit values comprise bit values of a plurality of second PUF cells of the plurality of PUF cells that are paired with the plurality of first PUF cells.

15. The method of claim 14, wherein the step of determining whether to allow the OTP load operation for reading the OTP cell array at least according to the result of the comparison operation comprises:
determining to allow the OTP load operation when the result of the comparison operation indicates that each first PUF cell of the plurality of first PUF cells has a bit value different from a bit value of a second PUF cell of the plurality of second PUF cells paired with the first PUF cell.

16. The method of claim 14, further comprising:
determining to perform a failure handling operation when a first PUF cell of the plurality of first PUF cells has a bit value same as a bit value of a second PUF cell of the plurality of second PUF cells paired with the first PUF cell;
wherein the failure handling operation comprises at least one of sending an alarm and forbidding the OTP load operation.

17. The method of claim 14, further comprising:
determining to perform an enrollment operation upon the plurality of PUF cells when the result of the comparison operation indicates that the plurality of first bit values and the plurality of second bit values are all the same.

18. The method of claim 13, wherein:
the first read operation is performed to read the plurality of first bit values from at least part of the plurality of PUF cells and the second read operation is performed to read the plurality of second bit values from the at least part of the plurality of PUF cells again.

19. The method of claim 18, further comprising:
determining to perform a failure handling operation when the result of the comparison operation indicates that the plurality of first bit values read by the first read operation are different from the plurality of second bit values read by the second read operation; and
wherein the failure handling operation comprises at least one of sending an alarm and forbidding the OTP load operation.

20. The method of claim 18, further comprising:
calculating a Hamming weight of the plurality of first bit values or the plurality of second bit values when the result of the comparison operation indicates that the plurality of first bit values read by the first read operation are same as the plurality of second bit values read by the second read operation; and
determining to allow the OTP load operation when the Hamming weight is within a predetermined range.

21. The method of claim 20, further comprising:
performing an enrollment operation upon the plurality of PUF cells when the Hamming weight is 0% or 100%; and
performing a failure handling operation when the Hamming weight is not 0%, 100% nor within the predetermined range;
wherein the failure handling operation comprises at least one of sending an alarm or forbidding the OTP load operation.
